(19) United States
(12) Patent Application Publication
(10) Pub. No.: US 2013/0282525 A1
(43) Pub. Date: Oct. 24, 2013

(54) METHOD TO FACILITATE THE ORDERING OF PRODUCTS

(71) Applicant: Mark Hampton, Swanson (NZ)

(72) Inventor: Mark Hampton, Swanson (NZ)

(21) Appl. No.: 13/449,760

(22) Filed: Apr. 18, 2012

(51) Int. Cl. G06Q 30/06

(52) U.S. Cl. 705/26.43

(57) ABSTRACT

A method to facilitate the ordering of products offered for sale on a merchant's website by a user through an agent is provided. The method includes the steps of collecting, on the user processing device, data permitting an identification of a first merchant's website being viewed by the user and an identification of a first product presented on this website (first identification data) automatically by executing a computer program; and transferrin, from the user processing device to an agent processing device, the first identification data.

### TECHNICAL FIELD

The invention relates to a method for facilitating the ordering of products offered for sale on a merchant's website by a user through an agent, and, more particularly, to a method for facilitating the ordering of products via electronic communication networks like the internet.

### BACKGROUND OF THE INVENTION

Methods for ordering goods in online stores have long been known. Typically, an online store operates a website provided on a server and accessible via an electronic communication network, for example the internet, of client computers. When a potential customer wants to buy a good that is offered in the online store so he loads the home page of the online store on a client computer accessible to him. Normally, he enters data on the website allowing an identification of the product. When the customer actually wants to buy the product he typically adds the product to a virtual shopping cart and then concludes the order by entering data allowing the identification of the customer. By means of these customer data the product in the shopping cart can then be sent by the online store to the customer.

However, there are some cases where it's true that the potential customer wants to buy the product offered by the online store, but won't enter into any contractual relationship with the online store. A direct purchase of the product by the customer at the online store could be detrimental to the customer for example because
the online store of a third party offers better purchase conditions;
a direct purchase requires the revelation of customer data which the customer won't reveal over the online store;
the online store operates several websites with national orientation and allows the customer to buy the product only via the website that is intended for the customer's place of residence or the address of the client computer that is used by the customer;
the costs of the product incurred by the customer in purchasing the product are higher than if an agent orders the product for the customer, for example due to forwarding expenses or taxes.

Further, so-called “Personal Shopper” services are known from the prior art where customers send their order to an agent. Normally, the ordering of the goods via a Personal Shopper service comprises the steps of identifying one or more items to be purchased; then contacting the agent, that is the “Personal Shopper”; and manually providing the product data to the agent. This process is however error-prone, time-consuming and cost expensive from the perspective of the customer as well from that of the agent.

### SUMMARY OF THE INVENTION

An embodiment of the present invention provides a method to facilitate the ordering of products offered for sale on a merchant's website by a user through an agent, wherein the method comprises collecting, on the user processing device, data permitting an identification of a first merchant's website being viewed by the user and an identification of a first product presented on this website (first identification data) automatically by executing a computer program; and transferring, from the user processing device to an agent processing device, the first identification data. Preferably, the computer program does not require a modification or adaption of a merchant's web site to enable the user to collect and transfer the first identification data.

Preferably, the computer program is executed on the user processing device by a web browser running on it. In one embodiment of the invention, the computer program is a bookmarklet. A bookmarklet is unobtrusive JavaScript preferably stored as the URL of a bookmark in a web browser running on the user processing device or as a hyperlink on a web page being present within a web browser running on the user processing device. A bookmarklet can be saved and used as a normal bookmark. As such, it could be considered a simple “one-click” tool that adds functionality to the web browser running on the user processing device.

In another embodiment of the present invention, the computer program is a browser extension. The browser extension extends the functionality of a web browser running on the user processing device. An example of a browser extension is a browser toolbar. A browser toolbar adds additional buttons to the interface of the web browser to enable the user to collect and transfer the first identification data. However, a browser extension requires a lot of trust from the user because it can he used improperly, for example to monitor where the user navigates.

According to another embodiment of the present invention, the method further comprises the steps of transferring, from the agent processing device to the merchant's website or to a website assigned to another merchant offering the same product, data identifying the first product (second identification data); and providing the first product through the agent to the user.

According to another embodiment of the present invention, an interface is presented to the user, by executing the computer program, on the user processing device enabling an modification of first identification data automatically collected or an input of further first identification data.

According to another embodiment of the present invention, the method further comprises the step of receiving, by the user processing device from the agent processing device, program code enabling the execution of the computer program on the user processing device. If the computer program is a bookmarklet, the program code enabling the execution of the computer program is its scripting language JavaScript.

According to another embodiment of the present invention, the first identification data are selected from a group consisting of the URL of the product, the name of the product, the price of the product, one or more photos of the product, one or more identification numbers of the product, or combinations thereof. The first identification data are preferably extracted from the merchant's website by executing the computer program. According to the invention, the first identification data comprise data permitting an identification of a merchant's website being viewed by the user and an identification of a product presented on this website. Data permitting an identification of a merchant's website being viewed by the user are typically the URL of this website. The term “URL of the product” means the URL of a website showing data relating to only one product. The URL of the product and the URL of the merchant's website may be identical, but this is not required. The URL of the product typically comprises information permitting an identification of the merchant's website being viewed by the user. Additionally, the URL of the product may comprise further information permitting an unambiguous identification of the product. For this reason, product data are not only data typically used to characterize a product like the name of the product, the price of the product, one or more photos of the product, one or more identification numbers of the product, but also the URL of the product. By comparison of the URL of the product with said typical data, it can be checked whether there are discrepancies in the product data entered by a user and the URL of the product.

According to another embodiment of the present invention, the second identification data are selected from a group consisting of the URL of the product, the name of the product, the price of the product, one or more photos of the product, one or more identification numbers of the product, or combinations thereof.

According to another embodiment of the present invention, the method further comprises the steps of generating a virtual shopping cart, assigned to the user, reflecting the products ordered by the user through the agent.

According to another embodiment of the present invention, the first product identified by its first identification data is added to the virtual shopping cart.

According to another embodiment of the present invention, the method further comprises the steps of receiving, by the user processing device, the virtual shopping cart from the agent processing device. The virtual shopping cart can then be modified on the user processing device by entering the first identification data of the first product or identification data of one or more further products. Subsequently, the modified virtual shopping cart is transferred to the agent processing device.

According to another embodiment of the present invention, the virtual shopping cart is present as part of an interface presented on the user processing device.

According to another embodiment of the present invention, the method further comprises the steps of receiving, by the agent processing device, the data identifying the user; and transferring, to the user processing device, the virtual shopping cart assigned to the user.

According to another embodiment of the present invention, the method further comprises the step of receiving, by the agent processing device, payment data from the user processing device.

Other aspects and advantages of the present invention can be seen upon review of the figures, the detailed description, and the claims that follow.

### BRIEF DESCRIPTION OF THE DRAWINGS

FIGS. 1(a)-(b) illustrate the method for ordering products from an online store according to an embodiment of the invention.

FIG. 2 illustrates the ordering of products from different online stores according to an embodiment of the invention.

FIG. 3 illustrates a system for implementation suitable to implement the embodiments according to the invention.

FIG. 4 is a flow diagram illustrating the ordering of products according to an embodiment of the invention.

FIG. 5 is a representation of a website provided by an agent processing device and loaded by the user on a user processing device for illustrating the installation of a bookmarklet in the web browser of the user.

FIG. 6 is a further representation of a website provided by an agent processing device and loaded by the user on a user processing device for illustrating the installation of a bookmarklet in the web browser of the user.

FIG. 7 is a representation of a message presented by on a user processing device for illustrating the installation of a bookmarklet in the web browser of the user.

FIG. 8 is a representation of a website provided by a first merchant processing device and loaded by the user on a user processing device for illustrating the addition of a product to the shopping cart of the user provided by the agent processing device.

FIG. 9 is a representation of a further message presented by on a user processing device for illustrating the installation of a bookmarklet in the web browser of the user.

FIG. 10 is a representation of a further message presented by on a user processing device for illustrating the installation of a bookmarklet in the web browser of the user.

FIG. 11 is a representation of a further message presented by on a user processing device for illustrating the installation of a bookmarklet in the web browser of the user.

FIG. 12 is a representation of a further message presented by on a user processing device for illustrating the installation of a bookmarklet in the web browser of the user.

FIG. 13 is a representation of a website provided by a second merchant processing device and loaded by the user on a user processing device for illustrating the addition of a product to the shopping cart of the user provided by the agent processing device.

FIG. 14 is a representation of a website provided by an agent processing device and loaded by the user on a user processing device for illustrating the shopping cart of the user after adding products.

### DETAILED DESCRIPTION OF THE INVENTION

The following description and claims relate to a method that allows a user to order products offered for sale in an online store through an agent.

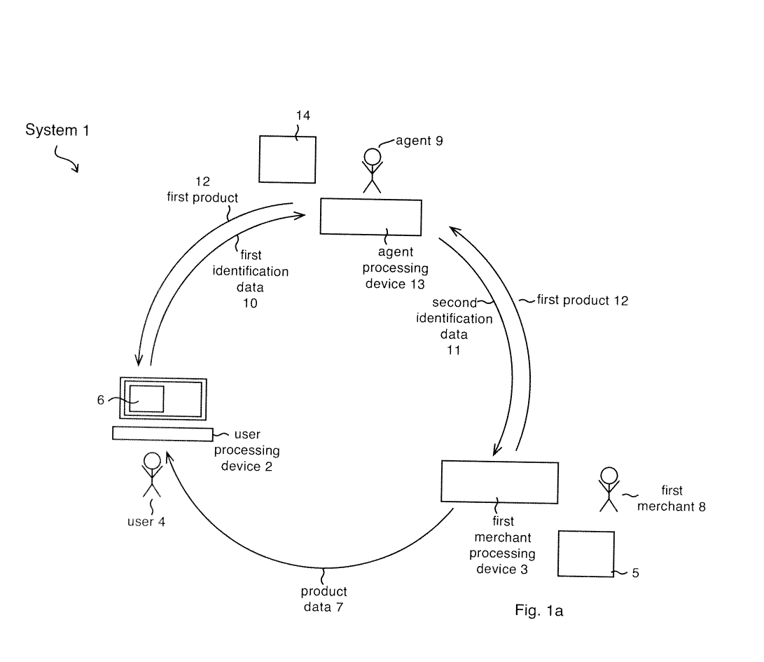

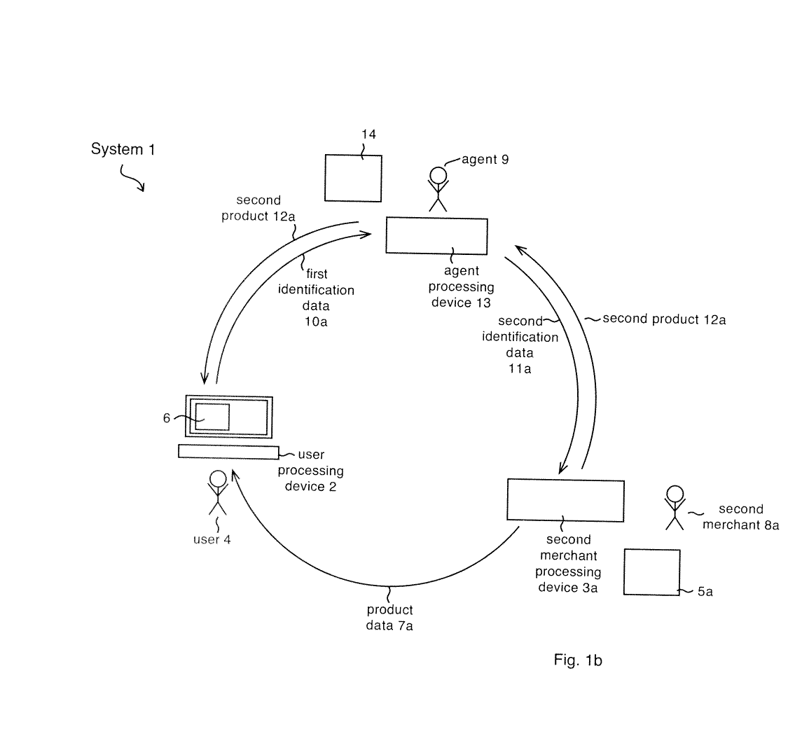

FIG. 1a illustrates a system 1 comprising a user processing device 2, an agent processing device 13, and a merchant processing device 3. A user 4 can load a website 5 on its user processing device 2 by means of a web browser 6 that is provided by a merchant 8 on its merchant processing device.

Website 5 is a website on which products are offered for sale. The user can load the website 5 via its user processing device 2 and navigate there. Here, he can choose a first product 12 and load its product data 7.

When the user 4 decides to buy a product 12 offered on the website 5 of the merchant 8, however he does not add the product to the virtual shopping cart provided on the website 5 of the merchant 8. Instead, he adds the product to a virtual shopping cart provided on the website 14 by an agent processing device 13 of the agent 9. Here, identification data 10 are transmitted from the user processing device 2 to the agent processing device 13.

Then, agent 9 orders the first product 12 from merchant 8. In one embodiment, for that he transmits second identification data 11a characterizing the product 12 to the merchant processing device by entering the data via the website 5 that he loads on his agent processing device 13 in a web browser and then adding the product 12 to the virtual shopping cart provided on the website 5 of the merchant 8. In one embodiment of the invention the agent 9 appears as the purchaser. With that, the ordering process for ordering the first product is completed.

Then, product 12 is delivered by the merchant 8 to the agent 9 which in turn delivers it to the user 4. In one embodiment of the invention, however agent 9 collects several products, ordered by the user 4, in a warehouse and only delivers them, when the user 4 explicitly requests it. In this case, the agent 9 can send several products in one shipment to the user 4.

The further products must not be ordered from the same merchant 8. FIG. 1b illustrates the ordering of a second product 12a from a second merchant 8a. A user 4 can load a website 5 on its user processing device 2 by means of a web browser 6 that is provided by a merchant 8a on its merchant processing device 3a.

Website 6 is a website on which products are offered for sale. The user can load the website 6 via its user processing device 2 and navigate there. Here, he can choose a second product 12a and load its product data 7a.

When the user 4 decides to buy a second product 12a offered on the website 5a of the merchant 8a, he also does not add the product to the virtual shopping cart provided on the website 5a of the merchant 8a. instead, he adds product 12a to a virtual shopping cart provided on the website 14 by an agent processing device 13 of the agent 9. Here, identification data 10a are transmitted from the user processing device 2 to the agent processing device 13.

Then, agent 9 orders the second product 12a from merchant 8a. In one embodiment, for that he transmits second identification data 11a characterizing the product 12a to the merchant processing device by entering the data via the website 5 that he loads on his agent processing device 3 in a web browser and then adding the product 12a to the virtual shopping cart provided on the website 5a of the merchant 8a. In one embodiment of the invention the agent 9 appears as the purchaser. With that, the ordering process for ordering the first product is completed. Once the second merchant 8a has delivered the second product 12a to the agent 9 he can deliver the second product 12a to the user 4. In one embodiment of the invention the delivery can be done along with the first product 12.

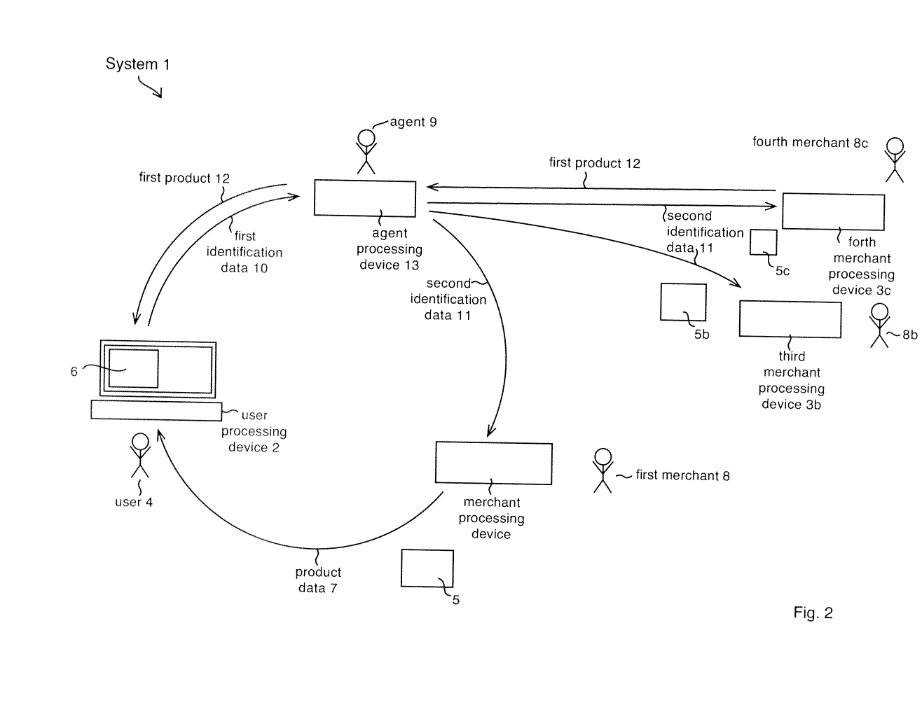

FIG. 2 illustrates an embodiment of the invention, wherein the agent 9 decides not to order product 12 from the first merchant 8, but from another merchant, referred to as further merchant 8d. Agent 9 can decide to order product 12 from another merchant than merchant 8 the website of which user 4 has originally loaded. Reasons for that may be for example differences in the conditions of contract or the delivery time of product 12. Conditions of contract are in particular the price of the product and the costs of delivery.

In ordering product 12 the user 4 also acts as shown in FIG. 1a. Via his web browser 6 running on his user processing device 2 he loads website 5, there chooses the first product 12 by loading its product data 7.

When the user 4 decides to buy the first product 12 offered on website 5 of the merchant 8, he does not add this product to the virtual shopping cart provided on the website 5 of the merchant 8. Instead, he adds product 12 to a virtual shopping cart provided on a website 14 by an agent processing device 13 of agent 9. Here, first identification data 10 are transmitted from e user processing device 2 to the agent processing device 13.

Now, different from FIG. 1a, agent 9 transmits the second identification data 11 of the first product 12 not only to the first merchant 8, but to other merchants that in FIG. 2 are referred to as third merchant 8b operating a website 5b on a third merchant processing device 3b, and as fourth merchant 8c operating a website 5c on a fourth merchant processing device 3c. The merchants also offer product 12, but possibly with other conditions of contract, delivery times, or both. Although, in FIG. 2 there are shown only two other merchants, the agent 9 may transmit the second identification data 11 to further merchants. Now, the agent can compare the product data 7 of product 12a at various merchants and decide for ordering the product from one of the merchants. In FIG. 2 this is the fourth merchant 8c.

In one embodiment he transmits the second identification data 11 characterizing the product 12 to the merchant processing device by entering the data about the website 5c that he loads on his agent processing device 13 in a web browser and then adding product 12 to the virtual shopping cart provided on the website 5c of merchant 8c. In one embodiment of the invention agent 9 appears as the purchaser. With that, the ordering process for ordering the first product 12 is completed.

Then, product 12 is delivered from merchant 8c to agent 9, which in turn delivers it to the user 4. In one embodiment of the invention, however agent 9 collects several products, ordered by the user 4, in a warehouse and only delivers it when the user 4 explicitly requests it. In this case, agent 9 can send several products in one shipment to the user 4.

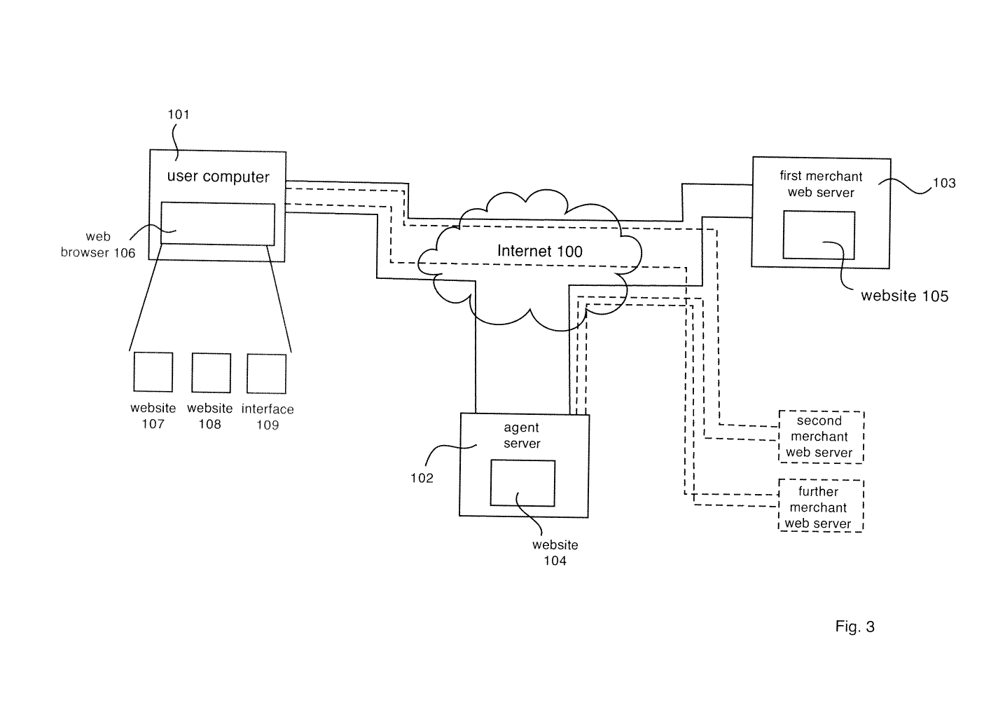

FIG. 3 illustrates one embodiment of the invention, wherein the user processing device, the agent processing device, and the merchant processing devices are computers or servers connected via the internet 100. Here, the user processing device 2 is a computer 101 connected via the internet 100 to the agent server 102. Agent server 102 is an agent processing device 13 operated by an agent 9. On the agent server 102 the agent 9 provides a website 104 that the user 4 can load via the computer 101 and the web browser 106. The computer 101 is also connected to a first merchant web server 103 via the internet 100. The first merchant web server 103 is a merchant processing device 3 operated by a merchant 8. On the first merchant web server 103 the merchant provides a website 105 that the user 4 can load via the computer 101 and the web browser 106. Furthermore, there is a connection via the internet 100 between the agent server 102 of the agent 9 and the first merchant web server 103 of the merchant 8. Moreover, there can be connections via the internet 100 between the computer 101 and the servers of further merchants 8b, 8c, 8d as well as the agent server 102 of the agent 9 and the servers of the further merchants 8b, 8c, 8d. For illustration, in FIG. 3 there are shown a server 103a of a second merchant 8b and a server 103b of a third merchant 8c. However, further servers of other merchants may be provided.

On the computer 101 the user 4 may execute a web browser 106 with which he can load the website 105 of the merchant 8 from its first merchant web server 103. This website 105 is represented on the computer 101 as website 107. Moreover, the user 4 can load on the computer 101 the website 104 of the agent 9 from its agent server 102. Website 104 is represented on the computer 101 as website 108. When the user 4 loads the website 104 for the first time, so from there he can get the program code which allows him to execute an additional interface 109 on the computer 101 that facilitates the order of a product 12 via the agent server 102.

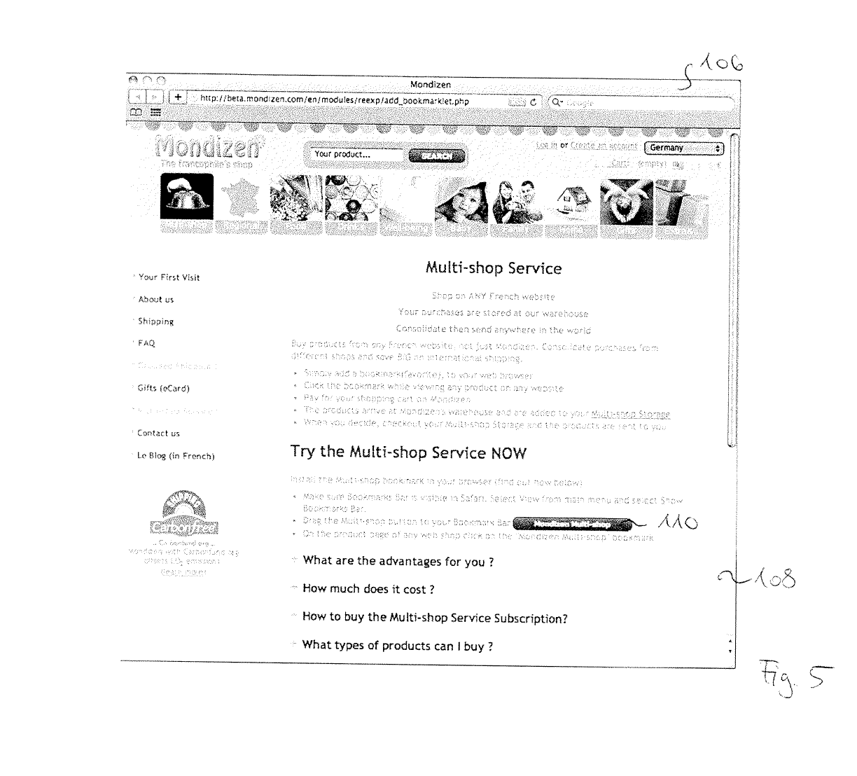

FIG. 5 illustrates one embodiment of a website 108 represented in the web browser 106 on the user computer 101. With said website 108 a user 4 that for the first time wants to order a product offered on the website 105 of a merchant 8 via the agent server 102 by the method according to invention is requested to install a program code on his computer 101. To install the program code, an element 110 can be indicated in the website that the user 4 has to install as bookmark 111 in his web browser 107.

The program code may be a bookmarklet. A bookmarklet is a macro extending the functionality of the web browser 106. The bookmarklet is written in a scripting language that the web browser 106 can execute. In one embodiment of the invention the scripting language is JavaScript. The bookmarklet has the advantage that the functionality of the web browser is extended without the requirement to change the website 105 provided on the first merchant web server 103 of the merchant 8.

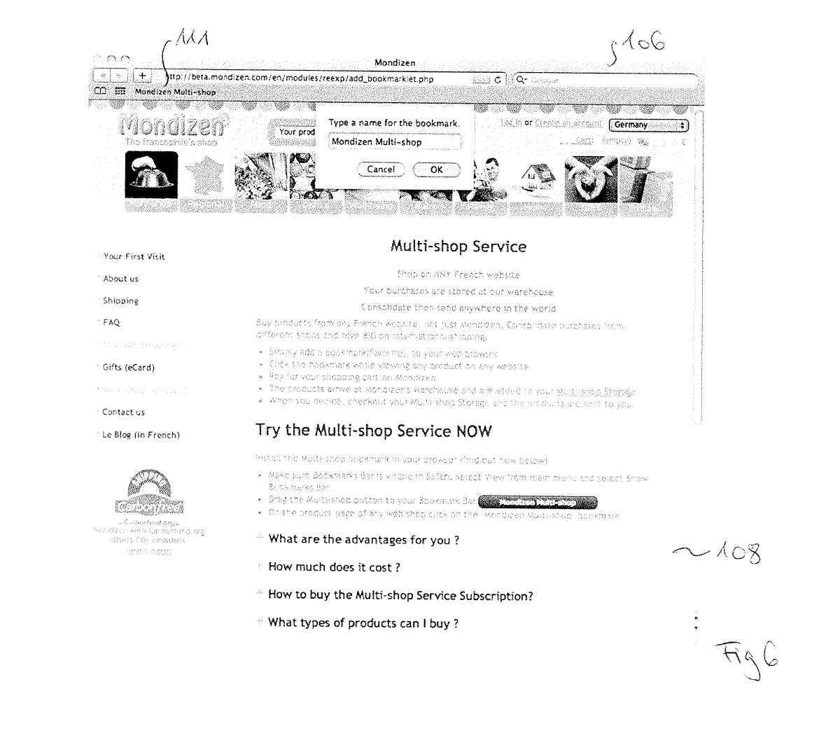

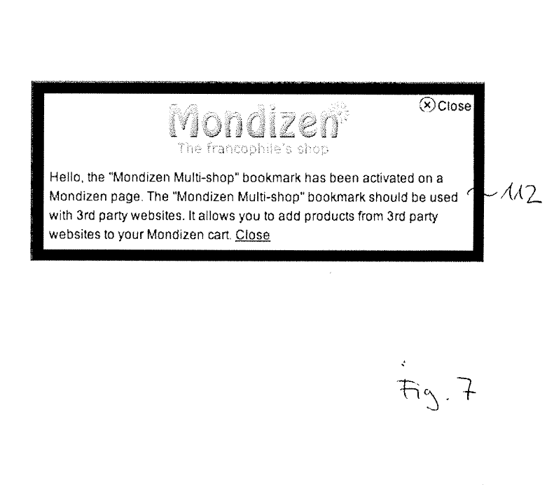

FIG. 6 illustrates the installation of the bookmarklet in the web browser 106. There, the bookmarklet can now be loaded via a bookmark 111. A confirmation of the successful installation of the bookmarklet is given to the user 4 with a message in the web browser 106. In FIG. 7 message 112 is shown which confirms the installation of the bookmarklet as bookmark 111.

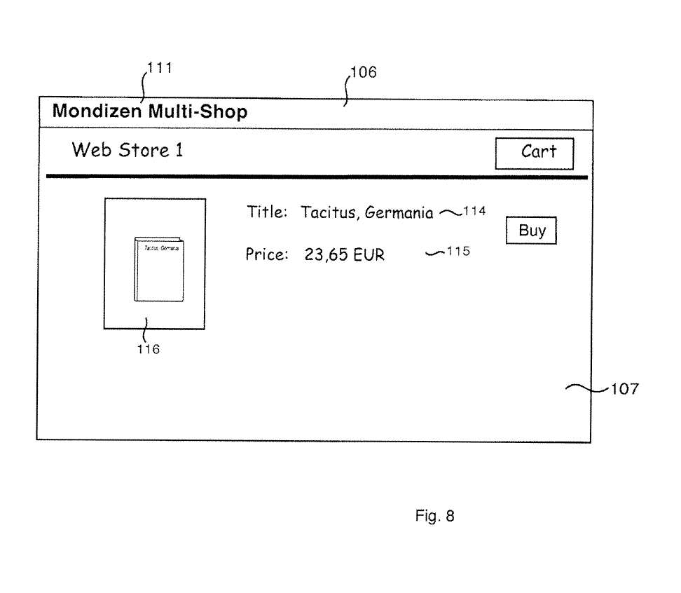

FIG. 8 illustrates a website 107 indicated in the web browser 106 on the computer 101. The website 107 is the website 105 provided on the first merchant web server 103 of the merchant 8 and which has been transmitted via the internet 100 to computer 101. Website 105 is an online store wherein a number of products are offered. The user 4 navigates in the online store in the usual way except he doesn't put the products he wants to buy into the virtual shopping cart provided on the website 105 of merchant 8. In FIG. 8 there are given product data characterizing a product that the user 4 wants to buy. For that, he loads the bookmark 111 with which the bookmarklet is started.

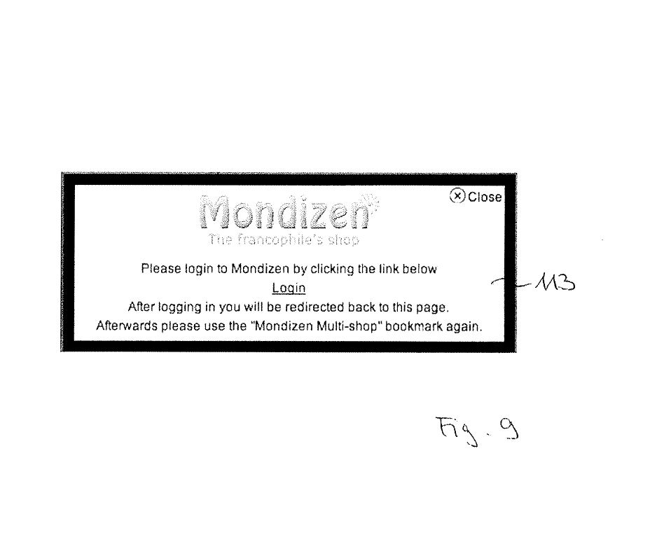

In one embodiment of the invention the user is now requested by a message indicated in his web browser 106 to log into a website 104 provided on the agent server 102 of the agent 9. In FIG. 9 message 113 is indicated which requests the user 4 to log into the website 104. To log in, in the web browser 106 website 104 is indicated as website 108 enabling the user 4 to enter user information such as name and password. After log in, in the web browser 106 again there is indicated website 107 illustrated in FIG. 8. The log in is not required if the user 4 is already logged in the website 104.

If the user 104 is logged in, the execution of the bookmarklet is continued. The bookmarklet collects product data 7 of the product 12 chosen by the user 4 as well as the URL of the website 105. As the website 105 contains the product data of product 12, the URL of the website 105 is at the same time the URL of product 12. The product data 7 and the URL of the website 105 are the first identification data 10. In one embodiment of the invention only the URL of the website 105 is automatically recorded in executing the bookmarklet. In another embodiment of the invention also all or a part of the product data 7 are automatically recorded in executing the bookmarklet. Product data 7 are all data required for the clear characterization of product 12. In the website 107 shown in FIG. 8 the product data 7 comprise an designation 114 of the product 12, its price 115 as well as a graphic representation 116 of product 12.

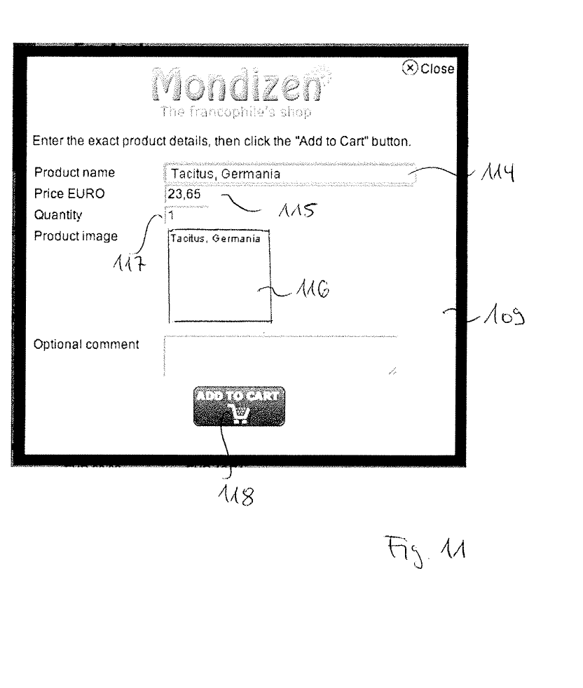

When in executing the bookmarklet the product data 7 can automatically be recorded the further execution of the bookmarklet results in the representation of the interface 109 shown in FIG. 11 in the web browser 106 in which the product data 7 are visibly represented to the user 4. In the embodiment of the invention shown the represented product data 7 are the designation 114 of the product 12, its price 115, and the graphic representation 116 of product 12 that have been extracted by the bookmarklet from the website 107 shown in FIG. 8. Additionally, the product data include the amount 117 of the product 12. If the user doesn't want to change the product data 7, he can activate element 118. By doing so, the bookmarklet is further executed to transmit product 12 to a virtual shopping cart provided by the agent server 102 of agent 9 on the website 104.

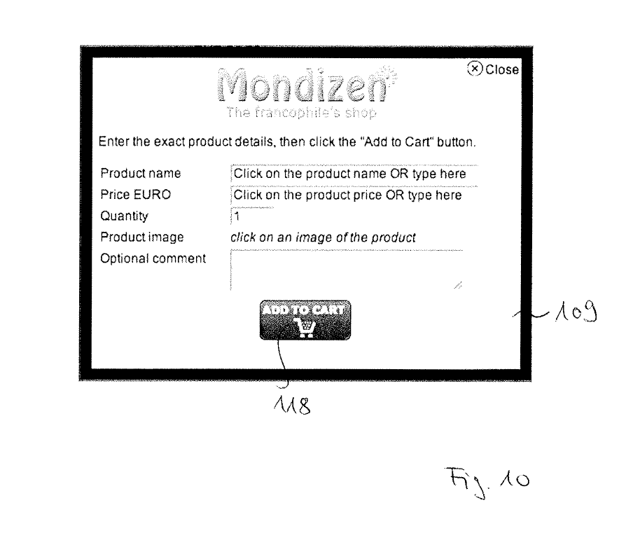

If in contrast in the execution of the bookmarklet the product data 7 cannot be recorded automatically, the further execution of the bookmarklet results in the representation of the interface 109 shown in FIG. 10 in the web browser 106 which requests the user 4 to enter the product data 7 by himself. Once this is done, the user can activate element 118. By doing so, the bookmarklet is further executed to transmit product 12 to the virtual shopping cart provided by the agent server 102 of agent 9 on the website 104.

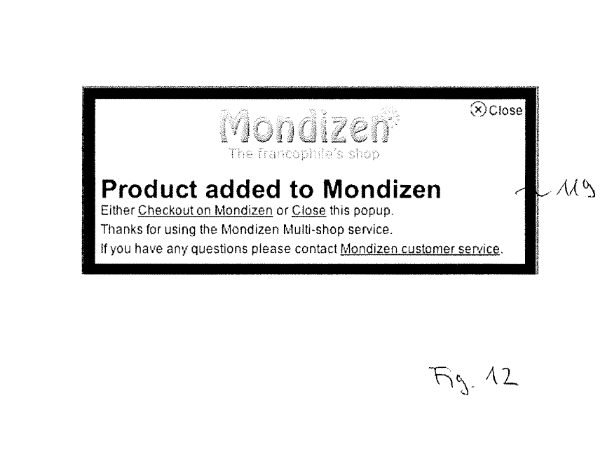

By the bookmarklet now the first identification data 10 are transmitted from the computer 101 to the agent server 102 of the agent 9, by which the product 12 is added to the virtual shopping cart provided on the agent server 102 of the agent 9. A confirmation of the transmission is given to the user 4 by a message in the web browser 106. FIG. 12 illustrates said message 119 that is indicated in the web browser 106 of the computer 101. The user 4 now has the option to close this message 119 or to further execute the bookmarklet, which then leads him to the virtual shopping cart provided on the agent server 102. For that, website 104 is indicated as website 108 in the web browser of the computer 101.

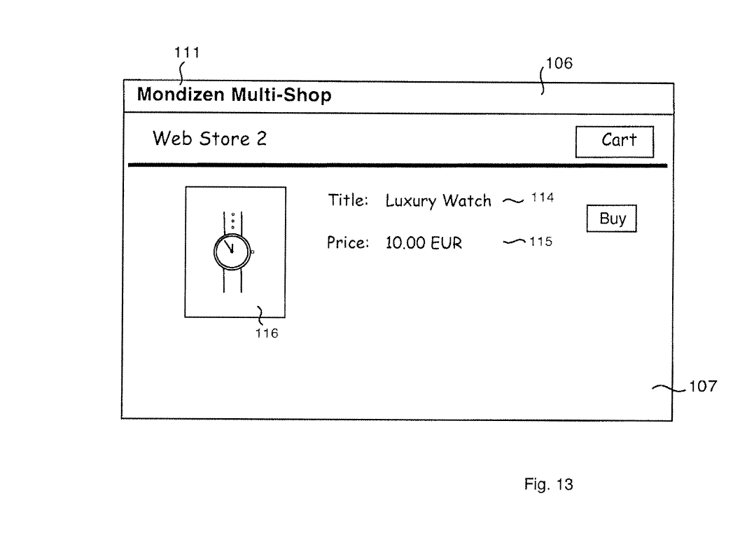

However, if the user 4 decides to buy a second product 12b, so he can load the website 107 of the merchant 8 again or a website of another merchant 8a. Such a website is shown in FIG. 13. There the product data 7a of a second product 12a offered by a second merchant 8 are shown in its web store. When the user decides to buy the product 12a, so he activates the bookmark 111. With that, in the same way as shown for the first product 12 in FIGS. 11 and 12 the second product is added to the virtual shopping cart provided on the agent server 102 of the agent 9.

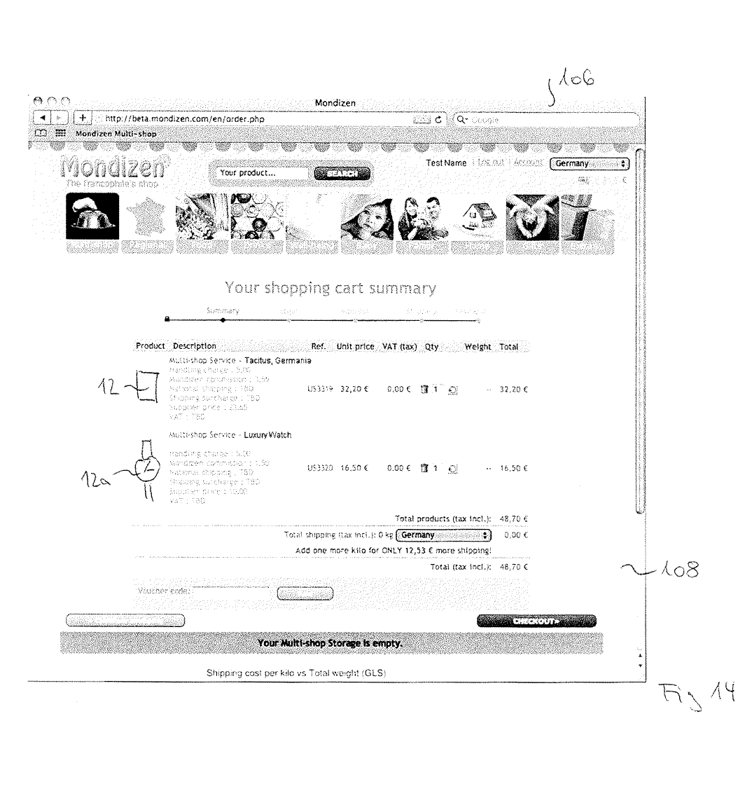

FIG. 14 illustrates a website 108 indicated in the web browser 106 of the computer 101. Here, website 108 shows the virtual shopping cart of the user 4 that is part of the website 104 provided on the agent server 102 of the agent 9. After loading this website 104 the user 4 can complete the purchase of the products 12 and 12a as he is accustomed to do in the conventional web stores. This includes in particular information on the type of the payment of the product. These information are transmitted from the computer 101 of the user 4 to the agent server 102 of the agent 9.

Now the agent 9, as shown in FIGS. 1 to 3, can transmit the second identification data 11 and 11a to the merchant. From the second identification data 11 and 11a the agent 9 takes the first identification data. The second identification data may be identical to the first identification data. However, if the agent decides for example to order the product 12 from another merchant, i.e. in a web store that is another than that loaded by the user 4 in executing the bookmarklet, the agent may be forced to get from the first identification data changed identification data, for example because the designation of the product in the web store of the other merchant is a different designation than in the web store the user 4 had loaded in executing the bookmarklet. Moreover, the second identification data in the ordering from another merchant include no longer data permitting an identification of a first merchant's website, i.e. the URL of the website the user 4 had originally loaded.

Once he got the products 12 and 12a from the merchants, he can transmit these products individually or together to the user 4.

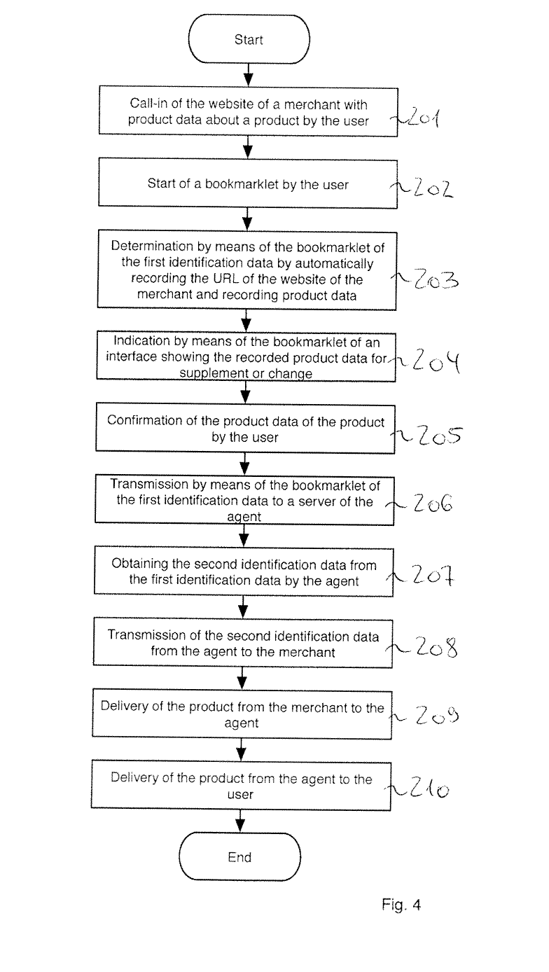

FIG. 4 shows a flow diagram illustrating the ordering of a product 12 according to one embodiment of the invention. The method 200 starts with step 201 comprising loading the website 105 operated by a merchant 8 on its server 103 in a web browser 106 by a user 4 on its computer 101. The computer 101 is connected to the first merchant web server 103 via the internet 100. The website 105 contains product data 7 about the product 12 the user 4 wants to buy. In the next step 202 the user 4 starts the bookmarklet. The bookmarklet, as shown in step 203, records the first identification data 10 from the website 105. Additionally, it automatically records the URL of the website 105. The established product data 7 are indicated to the user 4 in the web browser 106 in an interface 109 represented to the user in step 204 in executing the bookmarklet. The user 4 can change or supplement the product data 7 in the interface 109. Once in step 205 the user 4 has confirmed the shown or changed or supplemented product data, the product data 7 shown in the interface 109, by activating key 118 the first identification data 10 are transmitted from the computer 101 of the user 4 in step 206 via the internet 100 to the agent server 102 of the agent 9. The agent 9 determines in step 207 second identification data 11 from the first identification data 10 and transmits these to the merchant 8 in step 208 so as to order product 12. Then, in step 209 the merchant 8 delivers the product 12 to the agent 9 and he in step 210 the product 12 individually or along with other products to the user 4.

The foregoing description of the preferred embodiments of the present invention has been provided for the purposes of illustration and description. It is not intended to be exhaustive or to limit the invention to the precise forms disclosed. Obviously, many modifications and variations will be apparent to a person skilled in the art. It is intended that the scope of the invention be defined by the following claims and their equivalents.

### LIST OF REFERENCE NUMBERS

1 system

2 user processing device

3 merchant processing device

4 user

5 website (from first merchant)

6 web browser

7 product data

8 merchant

9 agent

10 first identification data

11 second identification data

12 product

13 agent processing device

14 website (from agent)

100 internet

101 computer

102 agent server

103 first merchant web server

104 website

105 website

106 web browser

107 website

108 website

109 interface

110 element

111 bookmark

112 message

113 message

114 designation

115 price

116 graphic representation

117 amount of product

118 key

1. A method to facilitate the ordering of products offered for sale on a merchant's website by a user through an agent, wherein the method comprises
collecting, on the user processing device, data permitting an identification of a first merchant's website being viewed by the user and an identification of a first product presented on this website (first identification data) automatically by executing a computer program; and
transferring, from the user processing device to an agent processing device, the first identification data.

2. The method of claim 1, further comprising
transferring, from the agent processing device to the merchant's website or to a website assigned to another merchant offering the same product, data identifying the first product (second identification data); and
providing the first product through the agent to the user.

3. The method of claim 1, wherein, by executing the computer program, an interface is presented to user on the user processing device enabling an modification of first identification data automatically collected or an input of further first identification data.

4. The method of claim 1, further comprising
receiving, by the user processing device from the agent processing device, program code enabling the execution of the computer program on the user processing device.

5. The method of claim 1, wherein the first identification data are selected from a group consisting of the URL of the product, the name of the product, the price of the product, one or more photos of the product, one or more identification numbers of the product, or combination thereof.

6. The method of claim 1, wherein the second identification data are selected from a group consisting of the URL of the product, the name of the product, the price of the product, one or more photos of the product, one or more identification numbers of the product, or combination thereof.

7. The method of claim 1, further comprising
generating a virtual shopping cart, assigned to the user, reflecting the products ordered by the user through the agent.

8. The method of claim 7, wherein the first product identified by its first identification data is added to the virtual shopping cart.

9. The method of claim 7, further comprising
receiving, by the user processing device, the virtual shopping cart from the agent processing device;
modifying the virtual shopping cart on the user processing device by entering the first identification data of the first product or identification data of one or more further products; and
transferring, to the agent processing device, the modified virtual shopping cart.

10. The method of claim 7, wherein the virtual shopping cart is present as part of an interface presented on the user processing device.

11. The method of claim 7, further comprising
receiving, by the agent processing device, the data identifying the user; and
transferring, to the user processing device, the virtual shoping cart assigned to the user.

12. The method of claim 1, further comprising
receiving, by the agent processing device, payment data from the user processing device.
